(19) United States
(12) Patent Application Publication
(10) Pub. No.: US 2011/0308453 A1
(43) Pub. Date: Dec. 22, 2011

(54) CLOSED LOOP MOCVD DEPOSITION CONTROL

(75) Inventors: Jie Su, Santa Clara, CA (US); Lori D. Washington, Union City, CA (US); David Bour, Cupertino, CA (US); Jacob Grayson, Santa Clara, CA (US); Sandeep Nijhawan, Los Altos, CA (US); Ronald Stevens, San Ramon, CA (US)

(73) Assignee: Applied Materials, Inc., Santa Clara, CA (US)

(21) Appl. No.: 12/812,222

(22) PCT Filed: Jan. 23, 2009
(86) PCT No.: PCT/US09/31831

§ 371 Date: Jun. 16, 2011

Related U.S. Application Data
(60) Provisional application No. 61/025,252, filed on Jan. 31, 2008.

(51) Int. Cl. B05C 11/00

(52) U.S. Cl. 118/708

(57) ABSTRACT

A method and apparatus are provided for monitoring and controlling substrate processing parameters for a cluster tool that utilizes chemical vapor deposition and/or hydride vapor phase epitaxial (HVPE) deposition. In one embodiment, a metal organic chemical vapor deposition (MOCVD) process is used to deposit a Group III-nitride film on a plurality of substrates within a processing chamber. A closed-loop control system performs in-situ monitoring of the Group III-nitride film growth rate and adjusts film growth parameters as required to maintain a target growth rate. In another embodiment, a closed-loop control system performs in-situ monitoring of film growth parameters for multiple processing chambers for one or more film deposition systems.

### BACKGROUND OF THE INVENTION

1. Field of the Invention

Embodiments of the present invention generally relate to methods and apparatus for process monitoring and control for chemical vapor deposition (CVD) on a substrate, and, in particular, to a closed-loop process control system for use in metal organic chemical vapor deposition and/or hydride vapor phase epitaxy processing system.

2. Description of the Related Art

Group III-V films are finding greater importance in the development and fabrication of a variety of semiconductor devices, such as short wavelength light emitting diodes (LEDs), laser diodes (LDs), and electronic devices including high power, high frequency, high temperature transistors and integrated circuits. For example, short wavelength (e.g., blue/green to ultraviolet) LEDs are fabricated using the Group III-nitride semiconducting material gallium nitride (GaN). It has been observed that short wavelength LEDs fabricated using GaN can provide significantly greater efficiencies and longer operating lifetimes than short wavelength LEDs fabricated using non-nitride semiconducting materials, such as Group II-VI materials.

One method that has been used for depositing Group III-V films, such as GaN, is metal organic chemical vapor deposition (MOCVD). This chemical vapor deposition method is generally performed in a reactor having a temperature controlled environment to assure the stability of a first precursor gas which contains at least one element from Group III, such as gallium (Ga). A second precursor gas, such as ammonia (NH₃), provides the nitrogen needed to form a Group III-nitride. The two precursor gases are injected into a processing zone within the reactor where they mix and move towards a heated substrate in the processing zone. A carrier gas may be used to assist in the transport of the precursor gases towards the substrate. The precursors react at the surface of the heated substrate to form a Group III-nitride layer, such as GaN, on the substrate surface.

Multiple substrates may be arranged on a substrate carrier within the deposition reactor for batch processing which is desirable in order to increase yield and throughput. These factors are important since they directly affect the cost to produce an electronic device and, thus, a device manufacturer's competitiveness in the market place.

The quality of the Group III-V film deposited on each substrate depends upon many film growth parameters, which include reactor pressure, precursor flow rates, substrate temperature, film stress, and film growth rate, to name a few. The growth parameters may be determined from the film growth rate or additional growth parameters, which are measured during and/or after previous substrate processing runs. Various metrology tools may be used to measure different film growth parameters, such as film stress and film growth rate, for example. It is desirable to measure and monitor film growth parameters during substrate processing in order to correlate process results with film growth parameters so that the film quality and growth rate may be optimized and reproduced on subsequent processing runs. The film growth parameters may then be monitored and adjusted as needed, by a human operator for example, to predetermined values or set-points to achieve the desired film qualities and growth rate.

One or more of the film growth parameters may drift away from desired predetermined values during substrate processing. The rate of drift may be so rapid or so gradual that the drift may go undetected by a human operator and the quality of the deposited films may be adversely affected for an entire batch of substrates. Also, cluster tools which have multiple processing reactors may require the monitoring of a large amount of film growth parameter data and the controlling many growth parameters which may increase the likelihood of operator error and poor film quality.

As the demand for LEDs, LDs, transistors, and integrated circuits increases, the efficiency of depositing high quality Group III-V films takes on greater importance. Therefore, there is a need for an improved apparatus and method for monitoring and controlling film growth parameters during substrate processing.

### SUMMARY OF THE INVENTION

The present invention generally provides improved methods and apparatus for monitoring and controlling the processing of Group III-V structures in an MOCVD and/or hydride vapor phase epitaxy processing system.

One embodiment provides a substrate processing system for monitoring and controlling the processing of Group III-V structures. The substrate processing system generally includes a chamber in which Group III-V films are deposited on a substrate, the chamber having a substrate carrier, one or more metrology tools adapted to measure a surface property of a substrate disposed on the substrate carrier, and a system controller for controlling process parameters of said chamber in accordance with measurements taken by the metrology tools.

Another embodiment provides a cluster tool for monitoring and controlling the processing of Group III-V structures. The cluster tool includes a transfer chamber, one or more processing chambers, where at least one of the processing chambers is adapted to deposit Group III-V films on a substrate, a service chamber, one or more metrology tools adapted to measure a surface property of a substrate, and a system controller for controlling process parameters of the one or more processing chambers in accordance with measurements taken by the metrology tools.

In yet another embodiment, a system for controlling two or more cluster tools, each having at least one chamber in which Group III-V films are deposited on a substrate, is provided. The system generally includes a first system controller for controlling process parameters of a first cluster tool, a second system controller for controlling process parameters of a second cluster tool, where at least one of the cluster tools has one or more metrology tools adapted to measure a surface property of a substrate, and an inter-system controller for controlling process parameters of said two or more cluster tools in accordance with measurements taken by the one or more metrology tools.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a gallium nitride based structure;

FIG. 2A is a schematic view of a chemical vapor deposition apparatus according to one embodiment of the invention;

FIG. 2B is a schematic view of a chemical vapor deposition apparatus according to another embodiment of the invention;

FIG. 3A is a schematic view of the chemical vapor deposition chamber shown in FIG. 2A which includes metrology tools according to one embodiment of the invention;

FIG. 3B is a schematic view of the chemical vapor deposition chamber shown in FIG. 2A which includes metrology tools according to another embodiment of the invention;

FIG. 4A is a schematic plan view of one embodiment a processing system having processing chambers and metrology chambers adapted for substrate processing;

FIG. 4B is a plan view of a multi-system processing system according to one embodiment of the invention;

FIG. 4C is a plan view of another embodiment of the processing system shown in FIG. 4A; and

FIG. 5 illustrates a process sequence for fabricating a compound nitride semiconductor structure using the processing system shown in FIG. 4A according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally provide a method and apparatus that may be utilized for the fabrication of Group III-V structures using MOCVD and/or hydride vapor phase epitaxy (HVPE) deposition. Exemplary systems and chambers that may be adapted to practice the present invention are described in U.S. patent application Ser. No. 12/023,520, filed on Jan. 31, 2008, entitled “CVD Apparatus,” and U.S. patent application Ser. No. 12/023,572, filed on Jan. 31, 2008, entitled “Processing System for Fabricating Compound Nitride Semiconductor Devices,” which are both incorporated by reference above. Additional exemplary systems and chambers that may be adapted to practice the present invention are described in U.S. patent application Ser. No. 11/404,516, filed on Apr. 14, 2006, and U.S. patent application Ser. No. 11/429,022, filed on May 5, 2006, which are both herein incorporated by reference.

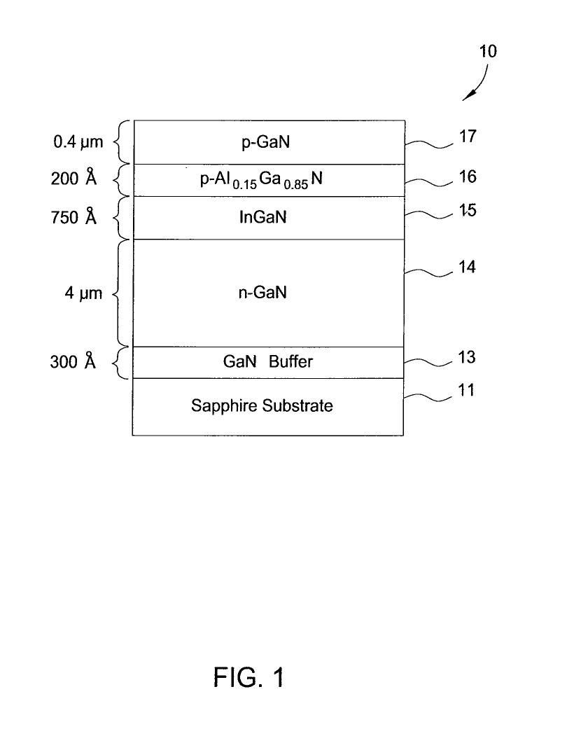

FIG. 1 is a schematic diagram of a gallium nitride based structure which illustrates the types of film layers and processing steps that may be used to fabricate such a structure. In the present example, shown in FIG. 1, the gallium nitride based structure is an LED (light emitting diode) structure 10. Fabrication begins with a cleaned sapphire substrate 11 over which is deposited a GaN (gallium nitride) buffer layer 13 having a thickness of about 300 angstroms. The GaN buffer layer 13 may be deposited using an MOCVD process which deposits GaN material at a processing temperature of about 550 degrees Celsius (° C.) for about 5 minutes.

Next, an n-GaN layer 14 is deposited over the GaN buffer layer 13. The n-GaN layer 14 is typically deposited at a higher temperature, for example, 1050° C., and is relatively thick with a thickness approximating 4 microns (μm) which may require a total deposition time of about 140 minutes. The next layer is an InGaN (indium-gallium-nitride) layer 15 which functions as a multi-quantum-well layer and which may be deposited to a thickness of about 750 angstroms at a temperature of 750° C. for about 40 minutes. Following the InGaN layer 15, a p-AIGaN (aluminum-gallium-nitride) layer 16 may be deposited over the InGaN layer 15 to a thickness of about 200 angstroms with deposition completed in about 5 minutes at an approximate temperature of 950° C. The final layer is be a p-GaN layer 17 which functions as contact layer and which is deposited at a temperature of 1050° C. for about 25 minutes for a final thickness of about 0.4 microns.

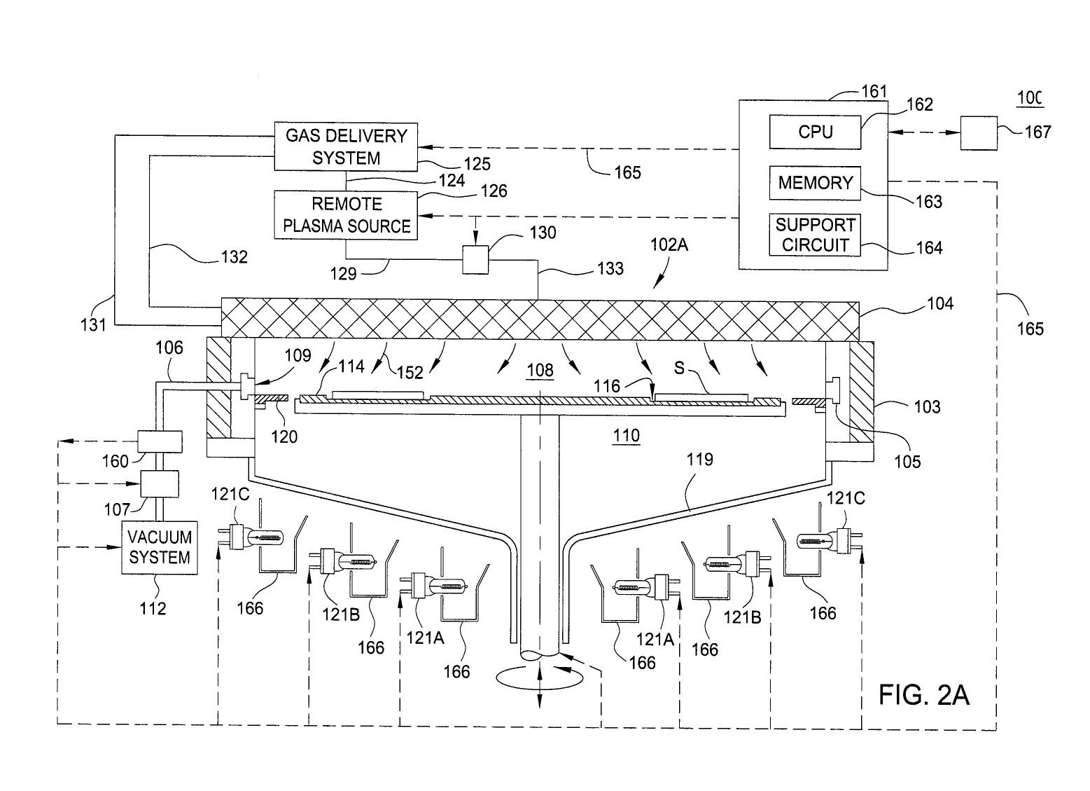

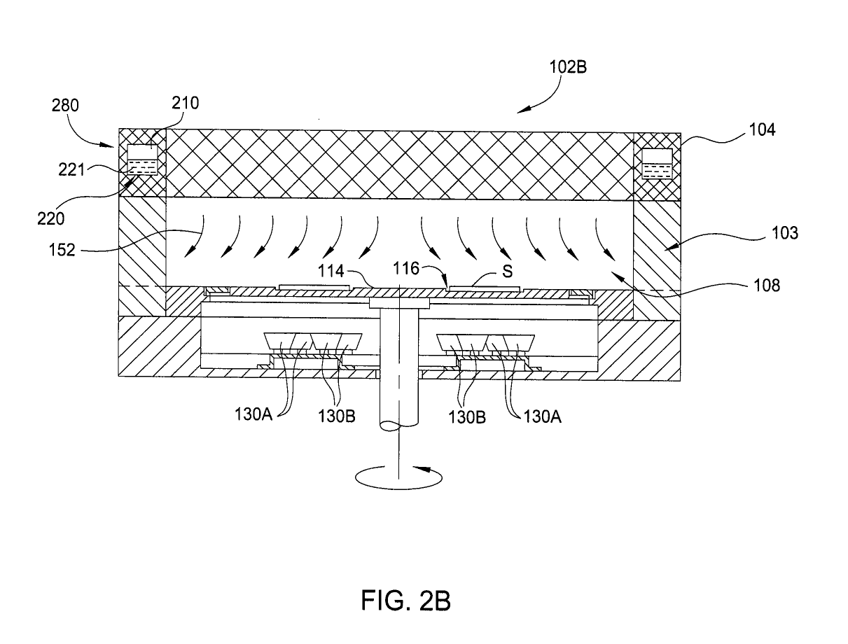

FIG. 2A is a schematic view of a chemical vapor deposition apparatus according to one embodiment of the invention. The LED structure described in FIG. 1 may be fabricated using the apparatus described in FIG. 2A. The apparatus 100 shown in FIG. 2A comprises a chamber 102A, a gas delivery system 125, a vacuum system 112, a remote plasma source 126, a system controller 161, and an operator interface 167. The chamber 102A includes a chamber body 103 that encloses a processing volume 108. A showerhead assembly 104 is disposed at one end of the processing volume 108, and a substrate carrier 114 is disposed at the other end of the processing volume 108. A lower dome 119 is disposed at one end of a lower volume 110, and the substrate carrier 114 is disposed at the other end of the lower volume 110. The substrate carrier 114 is shown in process position, but may be moved to a lower position where, for example, the substrates “S” may be loaded or unloaded. An exhaust ring 120 may be disposed around the periphery of the substrate carrier 114 to help prevent deposition from occurring in the lower volume 110 and also help direct exhaust gases from the chamber 102A to exhaust ports 109. The lower dome 119 may be made of transparent material, such as high-purity quartz, to allow light to pass through for radiant heating of the substrates “S”. The radiant heating may be provided by a plurality of inner lamps 121A, central lamps 121B, and outer lamps 121C disposed below the lower dome 119, and reflectors 166 may be used to help control chamber 102A exposure to the radiant energy provided by inner, central, and outer lamps 121A, 121B, 121C. Other lamp configurations may also be used for finer temperature control of the substrates “S”.

The substrate carrier 114 may include one or more recesses 116 within which one or more substrates “S” may be disposed during processing. The substrate carrier 114 may carry six or more substrates “S”. In one embodiment, the substrate carrier 114 carries eight substrates “S”. It is to be understood that more or less substrates “S” may be carried on the substrate carrier 114. Typical substrates “S” may include sapphire, silicon carbide (SiC), silicon, or gallium nitride (GaN). It is to be understood that other types of substrates, such as glass substrates, may be processed. Substrate size may range from 50 mm-100 mm in diameter or larger. The substrate carrier 114 size may range from 200 mm-750 mm. The substrate carrier 114 may be formed from a variety of materials, including SiC or SiC-coated graphite. It is to be understood that substrates of other sizes may be processed within the chamber 102A and according to the processes described herein. The showerhead assembly 104, as described herein, may allow for more uniform deposition across a greater number of substrates and/or larger substrates than in traditional MOCVD chambers, thereby increasing throughput and reducing processing cost per substrate.

The substrate carrier 114 may rotate about an axis during processing. In one embodiment, the substrate carrier 114 may be rotated at about 2 RPM to about 100 RPM. In another embodiment, the substrate carrier 114 may be rotated at about 30 RPM. Rotating the substrate carrier 114 aids in providing uniform heating of the substrates “S” and uniform exposure of the processing gases to each substrate “S”. The substrate carrier 114 may also be moved up or down to allow substrate processing and transfer of substrates to and from chamber 102A, and the vertical motion and rotation of substrate carrier 114 may be enabled by motors or actuators (not shown) which are controlled by system controller 161.

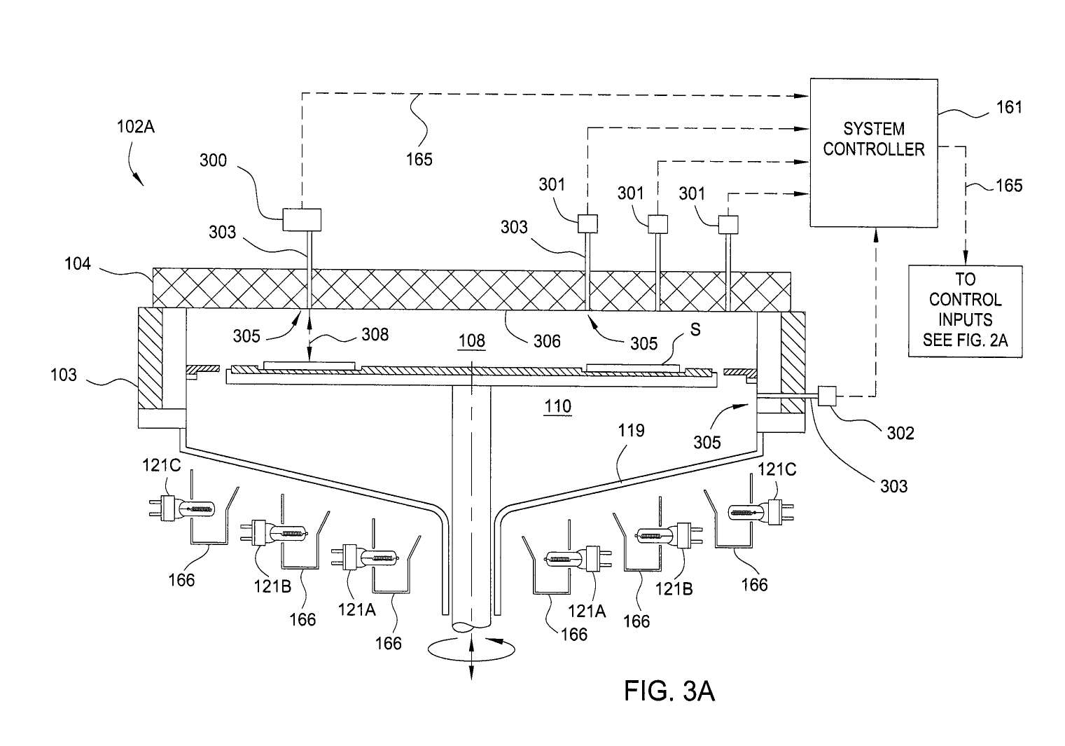

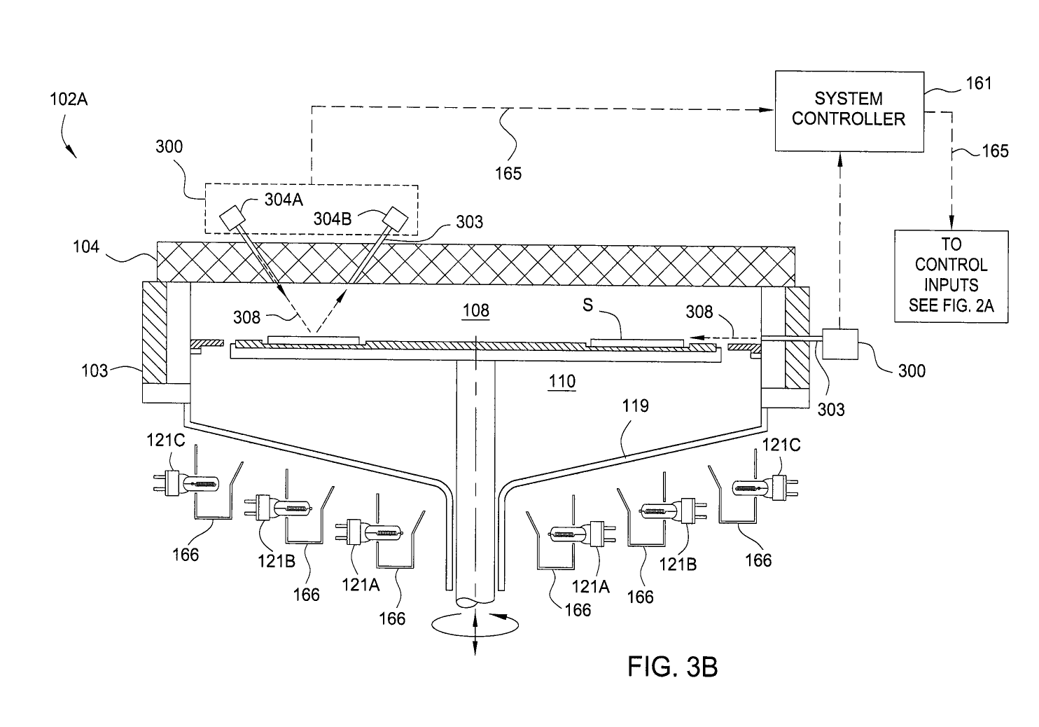

The plurality of inner, central, and outer lamps 121A, 121B, 121C may be arranged in concentric circles or zones (not shown), and each lamp or lamp zone may be separately powered. In one embodiment, one or more temperature sensors, such as pyrometers (see FIG. 3A), may be disposed within the showerhead assembly 104 to measure substrate and substrate carrier 114 temperatures, and the temperature data may be sent to the system controller 161 which can adjust power to the separate lamp zones to maintain a predetermined temperature profile across the substrate carrier 114. In another embodiment, the power to separate lamp zones may be adjusted to compensate for precursor flow or precursor concentration nonuniformity. For example, if the precursor concentration is lower in a substrate carrier 114 region near an outer lamp zone, the power to the outer lamp zone may be adjusted to help compensate for the precursor depletion in this region.

The inner, central, and outer lamps 121A, 121B, 121C may heat the substrates “S” to a temperature of about 400 degrees Celsius to about 1200 degrees Celsius. It is to be understood that the invention is not restricted to the use of arrays of lamps. Any suitable heating source may be utilized to ensure that the proper temperature is adequately applied to the chamber 102A and substrates “S” therein. For example, in another embodiment, the heating source may comprise resistive heating elements (not shown) which are in thermal contact with the substrate carrier 114.

A gas delivery system 125 may include multiple gas sources, or, depending on the process being run, some of the sources may be liquid sources rather than gases, in which case the gas delivery system may include a liquid injection system or other means (e.g., a bubbler) to vaporize the liquid. The vapor may then be mixed with a carrier gas prior to delivery to the chamber 102A. Different gases, such as precursor gases, carrier gases, purge gases, cleaning/etching gases or others may be supplied from the gas delivery system 125 to separate supply lines 131, 132, and 133 to the showerhead assembly 104. The supply lines 131, 132, and 133 may include shut-off valves and mass flow controllers or other types of flow controllers to monitor and regulate or shut off the flow of gas in each line, and said valves, flow controllers, and other gas delivery system 125 components may in turn be controlled by system controller 161.

A conduit 129 may receive cleaning/etching gases from a remote plasma source 126. The remote plasma source 126 may receive gases from the gas delivery system 125 via supply line 124, and a valve 130 may be disposed between the showerhead assembly 104 and remote plasma source 126. The valve 130 may be opened to allow a cleaning and/or etching gas or plasma to flow into the showerhead assembly 104 via supply line 133 which may be adapted to function as a conduit for a plasma. In another embodiment, apparatus 100 may not include remote plasma source 126 and cleaning/etching gases may be delivered from gas delivery system 125 for non-plasma cleaning and/or etching using alternate supply line configurations to showerhead assembly 104.

The remote plasma source 126 may be a radio frequency or microwave plasma source adapted for chamber 102A cleaning and/or substrate etching. Cleaning and/or etching gas may be supplied to the remote plasma source 126 via supply line 124 to produce plasma species which may be sent via conduit 129 and supply line 133 for dispersion through showerhead assembly 104 into chamber 102A. Gases for a cleaning application may include fluorine, chlorine or other reactive elements.

In another embodiment, the gas delivery system 125 and remote plasma source 126 may be suitably adapted so that precursor gases may be supplied to the remote plasma source 126 to produce plasma species which may be sent through showerhead assembly 104 via supply lines 131, 132 to deposit CVD layers, such as III-V films, for example, on substrates “S”. The remote plasma source 126 and gas delivery system 125 may be controlled according to predetermined operating parameters by system controller 161 during the cleaning and/or deposition process.

A purge gas (e.g., nitrogen) may be delivered into the chamber 102A from the showerhead assembly 104 and/or from inlet ports or tubes (not shown) disposed below the substrate carrier 114 and near the bottom of the chamber body 103. The purge gas enters the lower volume 110 of the chamber 102A and flows upwards past the substrate carrier 114 and exhaust ring 120 and into multiple exhaust ports 109 which are disposed around an annular exhaust channel 105. An exhaust conduit 106 connects the annular exhaust channel 105 to a vacuum system 112 which includes a vacuum pump (not shown). The chamber 102A pressure may be controlled using a valve system 107 which controls the rate at which the exhaust gases are drawn from the annular exhaust channel 105. A gas monitoring tool (e.g., residual gas analyzer, IR) 160 may be coupled to and in fluid communication with exhaust conduit 106. The gas monitoring tool 160 may be used to detect for leaks in chamber 102A, or to detect the end point of a chamber cleaning process, or for other gas analysis or monitoring purposes, and data from the gas monitoring tool 160 may be monitored by system controller 161.

The system controller 161 comprises a central processing unit (CPU) 162, a memory 163, and support circuits 164 for the CPU 162 and enables control of the operating parameters and activities of apparatus 100 and chamber 102A therein and, as such, of the deposition process. Signal lines 165 extending from the system controller 161 allow control signals to be sent from the system controller 161 to control inputs of various components (inner, central, outer lamps 121A-121C, vacuum system 112, for example) of apparatus 100 and chamber 102A. The operator interface 167 may comprise a keyboard, monitor, and other components which provide a means for the manual input of operating and processing parameters for the apparatus 100.

The system controller 161 may be one of any form of general-purpose computer processor that can be used in an industrial setting for controlling various chambers and sub-processors. The memory 163, or computer-readable medium of the CPU 162 may be one or more of readily available memory such as random access memory (RAM), read only memory (ROM), floppy disk, hard disk, or any other form of digital storage, local or remote. The support circuits 164 are coupled to the CPU 162 for supporting the processor in a conventional manner. These circuits include cache, power supplies, clock circuits, input/output circuitry and subsystems, and the like. The inventive method is generally stored in the memory 163 as a software routine, but can also be ASIC. Alternatively, such software routine may also be stored and/or executed by a second CPU (not shown) that is remotely located from the hardware being controlled by the CPU 162.

The showerhead assembly 104 shown in FIG. 2A for chamber 102A may be adapted for metal organic chemical vapor deposition (MOCVD) applications. During substrate processing, process gas 152 flows from the showerhead assembly 104 towards the surfaces of substrates “S”. The process gas 152 may comprise one or more MOCVD precursor gases as well as carrier gases and dopant gases which may be mixed with the precursor gases. Exemplary showerheads that may be adapted to practice the present invention are described in U.S. patent application Ser. Nos. 11/873,132, 11/873,141, and 11/873,170, all filed on Oct. 16, 2007, and all of which are incorporated by reference in their entireties.

In another embodiment, showerhead assembly 104 may be adapted for use in another deposition technique known as hydride vapor phase epitaxy (HVPE). The HVPE process offers several advantages in the growth of some Group III-V films, GaN in particular, such as high growth rate, relative simplicity, and cost effectiveness. In this technique, the growth of GaN proceeds due to the high temperature, vapor phase reaction between gallium chloride (GaCl) and ammonia (NH₃). The ammonia may be supplied from a standard gas source, while the GaCl is produced by passing a hydride-containing gas, such as HCl, over a heated liquid gallium supply. The two gases, ammonia and GaCl, are directed towards a heated substrate where they react to form an epitaxial GaN film on the surface of the substrate. In general, the HVPE process may be used to grow other Group III-nitride films by flowing a hydride-containing gas (such as HCl, HBr, or HI) over a Group III liquid source to form a Group III-halide gas, and then mixing the Group III-halide gas with a nitrogen-containing gas such as ammonia to form a Group III-nitride film.

The gas delivery system 125 may comprise a heated source boat (not shown) external to chamber 102A. The heated source boat may contain a metal source (e.g., Ga) which is heated to the liquid phase, and a hydride-containing gas (e.g., HCl) may flow over the metal source to form a Group III-halide gas, such as GaCl. The Group III-halide precursor gas and a nitrogen-containing precursor gas, such as NH₃, may then be delivered to showerhead assembly 104 via supply lines 131, 132 for injection into the processing volume 108 to deposit a Group III-nitride film, such as GaN, on substrates “S”. In another embodiment, one or more supply lines 131, 132 may be heated to deliver the precursors from an external boat to chamber 102A. The system controller 161 may be used to monitor and control the heating of various components of the gas delivery system 125.

FIG. 2B is a schematic view of a chemical vapor deposition apparatus according to another embodiment of the invention. The apparatus 100 may be suitably adapted to include a chamber 102B which is adapted for HVPE deposition. The chamber 102B includes a chamber body 103 that encloses a processing volume 108. The showerhead assembly 104 is disposed at one end of the processing volume 108, and a substrate carrier 114 is disposed at the other end of the processing volume 108. A plurality of lamps 130A, 130B may be disposed below the substrate carrier 114. For many applications, a typical lamp arrangement may comprise banks of lamps above (not shown) and below (as shown) the substrates “S”. One or more lamps 130A, 130B may be powered to heat the substrates “S” as well as a source boat 280 which is disposed within the showerhead assembly 104.

The source boat 280 may encircle the chamber body 103, and a metal source 221, such as gallium, aluminum, or indium, for example, may fill a well 220 of the source boat 280. The source boat 280 maybe heated so that the metal source 221 is heated to the liquid phase, and a hydride-containing gas (e.g., HCl) may flow through a channel 210 and over the metal source 221 to form a Group III-halide gas, such as GaCl, which is introduced into the processing volume 108 through gas tubes (not shown) located within showerhead assembly 104. A nitrogen-containing gas, such as ammonia, for example, may be introduced into the processing volume 108 through a separate set of gas tubes (not shown). During substrate processing, process gases 152 which may comprise the Group III-halide and nitrogen-containing precursor gases flow from the showerhead assembly 104 towards the substrates “S” where the precursor gases may react near or at the surfaces of the substrates “S” to deposit a metal nitride, such as GaN, for example, onto the substrate surfaces. Exemplary chambers and showerheads for HVPE deposition that may be adapted to practice the present invention are described in U.S. patent application Ser. No. 11/767,520, filed on Jun. 24, 2007, which is incorporated by reference in its entirety.

In order to improve substrate processing results it is often desirable to monitor the process either during processing or after so that any deviations from processing parameter setpoints can be corrected before one or more substrates complete processing. FIG. 3A is a schematic view of the chemical vapor deposition chamber shown in FIG. 2A which includes metrology tools 300 according to one embodiment of the invention. One or more sensors 301 and/or metrology tools 300 may be coupled to the showerhead assembly 104 in order to measure substrate processing parameters, such as temperature and pressure, for example, and various properties of films which are deposited on the substrates, such as thickness, reflectance, real-time film growth rate, composition, stress, roughness, or other film properties. Additional sensors 302 may be disposed along sidewalls of the chamber body 103, but the sensors 301, 302 may be located anywhere on chamber 102A. Data from the metrology tools 300 and/or sensors 301 can be sent along signal lines 165 to the system controller 161 so that the system controller 161 can monitor the data. In one embodiment, the system controller 161 is adapted to automatically provide control signals (see FIG. 2A) to apparatus 100 and chamber 102A in response to the metrology/sensor data to provide a closed loop control system.

Each of the sensors 301, 302 and/or metrology tools 300 is coupled to a conduit 303 which comprises a tube or extended housing or channel which forms a vacuum seal with the showerhead assembly 104 or chamber body 103 and which allows each sensor 301, 302 and/or metrology tool 300 to access the interior volume (e.g., processing volume 108 and/or lower volume 110) of chamber 102A while still maintaining chamber vacuum. One end of each conduit 303 is located near ports 305 disposed within showerhead assembly 104 and/or chamber body 103. The ports 305 are in fluid communication with the interior volume of chamber 102A. In another embodiment, one or more ports 305 include a window which allows light to pass through but which forms a vacuum seal to prevent fluid communication with the interior of chamber 102A.

Each conduit 303 houses a sensor/transducer probe or other device, and/or provides a path for a directed radiation beam, such as a laser beam. Each port 305 is adapted to flow a purge gas (which may be an inert gas) to prevent condensation on devices within ports 305 and conduits 303 and enable accurate in-situ measurements. The purge gas may have annular flow around the sensor probe or other device which is disposed inside conduit 303 and near ports 305.

In one embodiment, the sensors 301 comprise temperature sensors such as pyrometers or thermocouples, for example, to measure substrate “S” temperature and/or other temperatures, such as the temperature of the showerhead face 306. In other embodiments, sensors 302 comprise temperature sensors to measure the temperature of the chamber body 103 sidewalls. The showerhead face 306 and chamber body 103 are in fluid communication with one or more heat exchangers (not shown).

The sensors 301, 302 provide temperature data which is monitored by system controller 161 which may control the heat exchangers to regulate the temperatures of the showerhead face 306 and chamber body 103. In another embodiment, one or more sensors 301, 302 comprise pressure sensors which measure the pressure inside chamber 102A. The system controller 161 may be used to monitor and regulate the chamber pressure during various stages of substrate processing and chamber operation.

In one aspect of the invention, sensors 301 are pyrometers which are suitably located so that each pyrometer can monitor the temperature of a lamp zone, each lamp zone comprising inner, central, or outer lamps 121A, 121B, and 121C. The metrology tool 300 comprises a reflectometer which is used to measure film thickness and may be located on the showerhead assembly 104 so that beam 308, which may be a radiation beam or particle (e.g., laser beam, ion beam), may be reflected from the surface of a substrate “S”. As shown in FIG. 3A, the beam 308 may be directed almost perpendicular to the substrate surface.

FIG. 3B is a schematic view of the chemical vapor deposition chamber shown in FIG. 2A which includes metrology tools 300 according to another embodiment of the invention. In one embodiment, the metrology tool 300 comprises an emitter 304A and a receiver 304B. The emitter 304A emits beam 308 which strikes the substrate “S” at an angle and a portion of the beam 308 is reflected from the substrate surface back to receiver 304B. The received signal is then compared with the incident or emitted signal to measure a property of the substrate. The measurement results may then be communicated to the system controller 161 so that the system controller 161 can adjust one or more process parameters in the process sequence to improve the substrate processing results. In one embodiment, metrology tool 300 and conduits 303 are adapted so that the angle at which the beam 308 strikes the substrate “S” may be varied.

In another embodiment, one or more metrology tools 300 may be coupled to the chamber body 103. In one embodiment, the metrology tool 300 may be orientated so that beam 308 is directed approximately tangential to the substrate “S” surface in order to measure, for example, the substrate bow and associated film stress. In another embodiment, the metrology tool 300 comprises an emitter 304A and a receiver 304B which are located on opposing walls or along a diameter of the chamber body 103. In yet another embodiment, one or more metrology tools 300 may be disposed below substrate “S” or lower dome 119. The embodiments shown in FIGS. 3A and 3B and described herein may be combined and used with other embodiments described herein for chambers 102A and 102B.

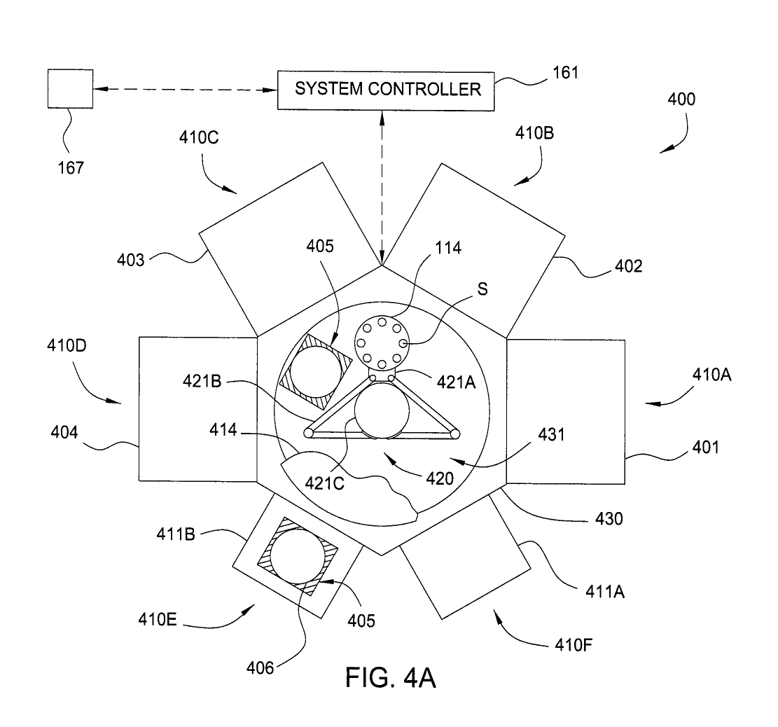

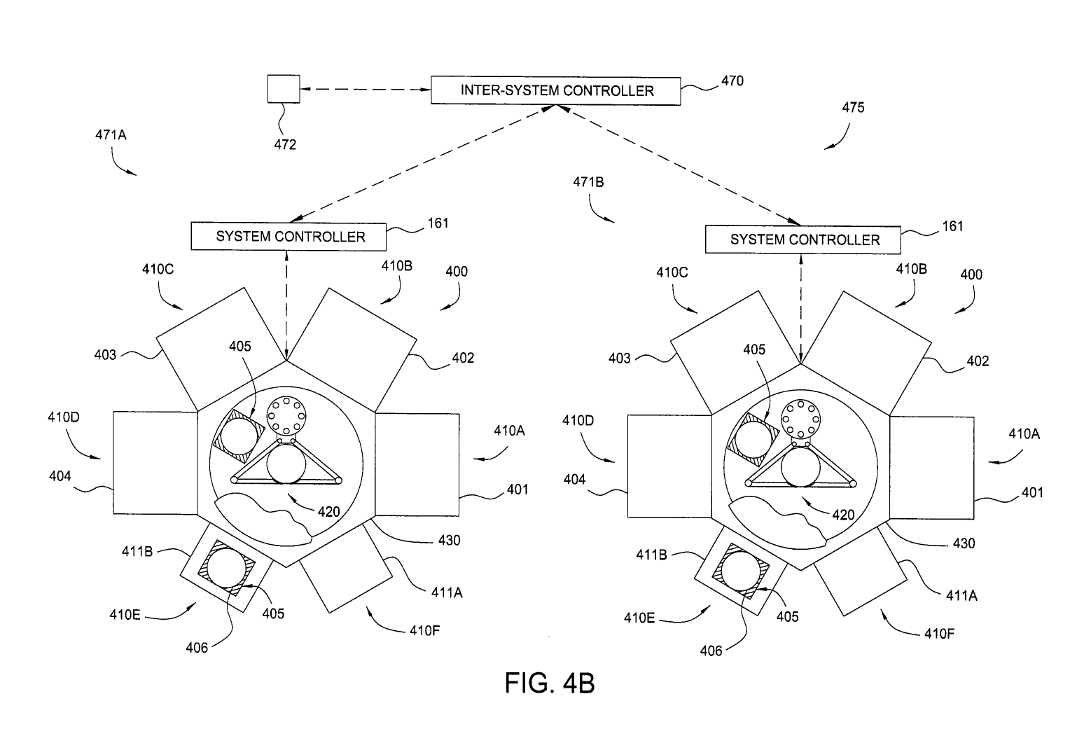

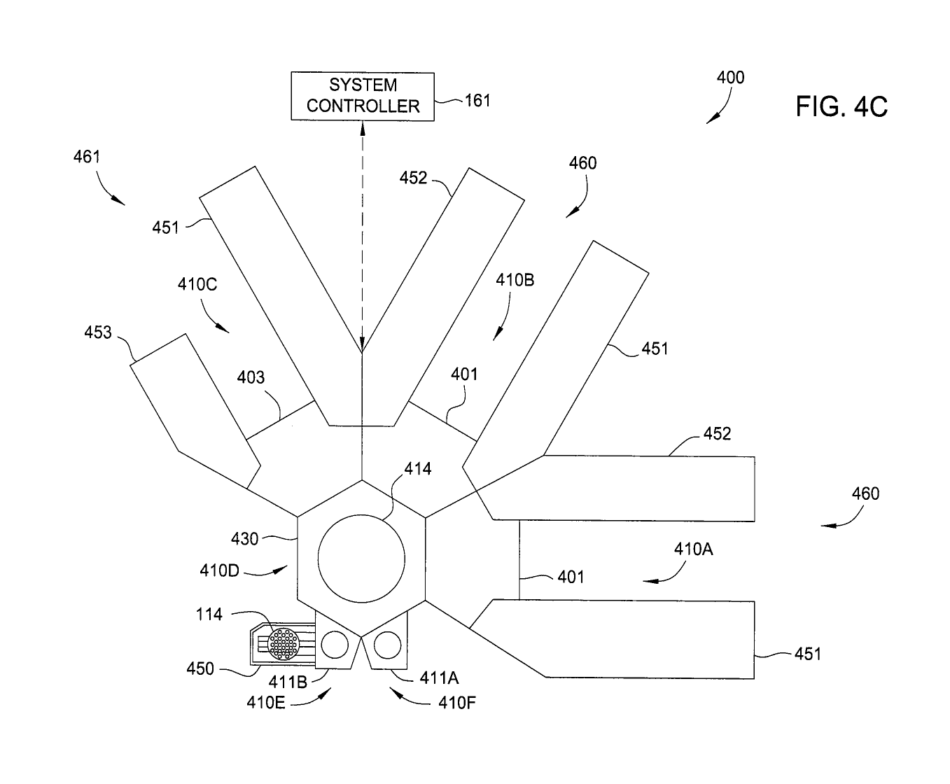

FIG. 4A is a schematic plan view of one embodiment a processing system having processing chambers and metrology chambers adapted for substrate processing. The chambers 102A and 102B and associated apparatus 100 may be used in a processing system which comprises a cluster tool 400 that is adapted to process substrates and analyze the results of the processes performed on the substrate. The cluster tool 400 is a modular system comprising multiple chambers that perform various processing steps that are used to form an electronic device. In one aspect of the invention, the cluster tool 400 includes a system controller 161 which is adapted to carry out various substrate processing methods and sequences and analyze the processing results.

In one embodiment, the cluster tool 400 includes substrate processing modules 401, 402, 403, and 404 which are mounted in positions 410A, 410B, 410C, and 410D, respectively, on a transfer chamber 430. The positions 410E and 410F may contain pre-processing or post-processing chambers, such as service chambers 411A and 411B that are adapted for degassing, orientation, cool down, pretreatment/preclean, post-anneal and the like. In some embodiments, not all of the positions 410A-410F are occupied with processing chambers or pre-processing or post-processing chambers to reduce cost or complexity of the system. In one aspect of the invention, the transfer chamber 430 is six-sided and hexagonal in shape with six positions 410A-410F for process chamber mounting. In another aspect, the transfer chamber 430 may have other shapes and have five, seven, eight, or more sides with a corresponding number of process chamber mounting positions.

Each of the substrate processing modules 401-404 includes a substrate processing chamber, such as chamber 102A or chamber 102B, and may also include one or more supporting modules which support various chamber functions, such as substrate heating and chamber cooling, for example. In one aspect of the invention, one or more of the substrate processing modules 401-404 may include another type of substrate processing chamber, such as a rapid thermal processing (RTP) chamber for substrate annealing, an epitaxial (EPI) deposition chamber, a chemical vapor deposition (CVD) chamber that is adapted to deposit a metal, semiconductor, or dielectric layer, an etch chamber, a sputtering (PVD) chamber, or other type of substrate processing chamber.

The transfer chamber 430 has an internal volume 431 which houses a robot 420 that is adapted to transfer substrates “S” between the processing chambers of substrate processing modules 401-404 and service chambers 411A and 411 B. The robot 420 generally includes a blade assembly 421A, arm assembly 421B, and drive assembly 421C. In one embodiment, the blade assembly 421A supports substrate carrier 114 which carries one or more substrates “S”, and the substrate carrier 114 is transferred between the processing chambers of substrate processing modules 401-404 and service chambers 411A and 411B.

The transfer chamber 430 includes a lid 414 (partially shown) and the internal volume 431 is maintained at a vacuum condition. In another embodiment, the internal volume 431 of the transfer chamber 430 may be maintained at or near atmospheric pressure by continually delivering an inert gas to the internal volume 431. In one embodiment, the internal volume 431 is filled with nitrogen gas and maintained at a pressure of about 80 Torr to about 200 Torr.

Referring to FIG. 4A, in one embodiment the service chamber 411B is a degas chamber and service chamber 411A is a batch load-lock (LL) chamber. The batch load-lock (LL) chamber may also function as a cool-down chamber for the substrates. In another embodiment, one of the service chambers 411A, 411B may be a dedicated cool-down chamber. An optional front-end environment (also referred to as a Factory Interface, not shown) may be positioned in selective communication with one or more service chambers 411A, 411B.

In one embodiment, the cluster tool 400 includes a system controller 161, a plurality of substrate processing modules 401-404, and one or more metrology chambers 405. The metrology chamber 405 includes one or more metrology tools 300 which are adapted to measure various properties of the substrates. The metrology chamber 405 may also include a substrate carrier support surface 406 and lift assembly (not shown) so that robot 420 may transfer the substrate carrier 114 to and from the metrology chamber 405.

In one embodiment, the metrology chamber 405 comprises an area or region disposed in another chamber, such as transfer chamber 430, service chambers 411A and 411B, and/or the processing chambers of substrate processing modules 401-404. In another embodiment, the metrology chamber 405 comprises a dedicated chamber designed primarily for measuring various substrate properties and not for substrate processing. The metrology chamber 405 may be located in any convenient position of the cluster tool 400 that is accessible by one or more of the cluster tool robotic devices, such as robot 420, for example.

As shown in FIG. 4A, a metrology chamber 405 may be located in one or more service chambers 411A, 411B and /or transfer chamber 430. Additionally, one or more metrology chambers 405 may be located within the transfer chamber 430 and at any suitable location within the transfer chamber 430. In one embodiment, a metrology chamber 405 may be located within a cool down chamber located at position 410E or 410F. In another aspect of the invention, a dedicated metrology chamber 405 may be located at any one of positions 410A-410F.

FIG. 4B is a plan view of a multi-system processing system according to one embodiment of the invention. The multi-system processing system 475 comprises a first cluster tool 471A, a second cluster tool 471B, an inter-system controller 470, and an operator interface 472. The first and second cluster tools 471A, 471B each comprise cluster tool 400 as described herein. In another embodiment, the multi-system processing system 475 may comprise three or more cluster tools 400. The operator interface 472 may comprise a keyboard, monitor, and other components which provide a means for the manual input of operating and processing parameters for the multi-system processing system 475.

Each of the cluster tools 400 of multi-system processing system 475 may have a different configuration for substrate processing modules 401-404, service chambers 411A, 4118, and metrology chambers 405. For example, the first cluster tool 471A may include one or more substrate processing modules 401-404 which are adapted only for HVPE deposition, and a dedicated metrology chamber 405 which is located at position 410D. The second cluster tool 471B may include at include two or more substrate processing modules 401-404 which are adapted for HVPE and MOCVD deposition, and metrology tools 300 located within one or more substrate processing chambers, such as chambers 102A and/or 102B. The system controllers 161 are linked to the inter-system controller 470 so that data may be feed forward and/or back between each system controller 161 and the inter-system controller 470

FIG. 4C is a plan view of another embodiment of the processing system shown in FIG. 4A. The cluster tool 400 comprises two MOCVD modules 460 and one HVPE module 461, each of which are mounted to transfer chamber 430. The MOCVD module 460 comprises substrate processing module 401, an auxiliary module 451 which may include supporting electrical modules, and a chemical delivery module 452 which is adapted to support MOCVD deposition. The substrate processing module 401 includes chamber 102A. The HVPE module 461 comprises substrate processing module 403, an auxiliary module 451, and a chemical delivery module 453 which is adapted to support HVPE deposition. The substrate processing module 403 may include either chamber 102A which is adapted for HVPE processing or chamber 102B.

The cluster tool 400 of FIG. 4C also includes service chamber 411A which comprises a batch load-lock chamber and service chamber 411B which is a degas chamber. A loading station 450 with substrate carrier 114 is coupled to the degas chamber. The cluster tool 400 may have various module configurations. In one embodiment, an HVPE module 461 is located at position 410D and an MOCVD module 460 is located at position 410A. Alternately, cluster tool 400 may comprise a single MOCVD module located at position 410A, for example.

As described herein, metrology chambers 405 may be located at various locations within one or more cluster tools 400 to allow measurements of various substrate properties. For in-situ measurements, one or more metrology tools 300 may be located within one or more substrate processing chambers, such as chambers 102A, 102B, for example. The properties of the substrate that can be measured include, but are not limited to, stress or strain in one or more layers deposited on the surface of the substrate, film composition of one or more deposited layers, the number particles on the surface of the substrate, and the thickness of one or more layers on the substrate. The data collected from the metrology tools 300 may then be used by the system controller 161 and/or inter-system controller 470 to automatically adjust one or more process parameters in one or more processing steps to produce desirable results on subsequently processed substrates for one or more cluster tools 400.

In one embodiment, one or more metrology tools 300 and/or metrology chambers 405 are adapted to measure the thickness and/or composition of a deposited film on the surface of the substrate using conventional optical measurement techniques which include ellipsometry, reflectometry, or X-ray photoelectron spectroscopy (XPS). In another embodiment, one or more metrology tools 300 and/or metrology chambers 405 are adapted to measure other properties of a deposited film on the surface of the substrate which may include but are not limited to film stress or strain, interface or surface roughness, chemical and electronic states of elements within the film material, and film defects and/or contaminants.

In one embodiment, one or more metrology tools 300 and/or metrology chambers 405 are adapted to employ one or more measurement techniques which include but are not limited to X-ray diffraction (XRD), X-ray fluorescence (XRF), X-ray reflectivity (XRR), Auger electron spectrometry (AES), transmission electron microscopy (TEM), atomic force microscopy (AFM), UV Raman spectroscopy, mass spectrometry (e.g., residual gas analyzer), energy dispersive spectroscopy (EDS/TEM), photoluminescence (PL) spectroscopy, electroluminescense (EL) spectroscopy (also referred to as flash LED spectroscopy), and acoustic wave detection techniques for measuring gas concentrations or substrate temperatures, for example. In one embodiment, a photoluminescence metrology tool 300 is located within a service chamber 411A, 411B which is a cooldown chamber so that photoluminescence measurements may be made during substrate cooling.

In another embodiment, one or more metrology tools 300 and/or metrology chambers 405 are adapted to measure substrate temperature using a technique known as band edge thermometry. When light is incident on a semiconductor crystal, there is a sharp increase in photon absorption when the photon energy is greater than the semiconductor crystal band-gap energy. The photon wavelength which corresponds to the band-gap energy is known as the band-edge wavelength and this wavelength is temperature dependent. Since the semiconductor crystal band-gap energy is inversely related to the lattice constant, the band-gap energy will decrease as the semiconductor crystal expands with increasing temperature and so the band-edge wavelength will increase. It has been recognized for some time that the band-gap energy is typically a smooth, almost linear function of temperature for temperatures in the range of 0° C.-1000° C., and so this semiconductor property forms a basis for a contactless, temperature measurement technique. The various types of metrology tools 300 described above may be incorporated into cluster tool 400 and used to improve the fabrication process of compound semiconductor structures, such as the gallium nitride based LED structure shown in FIG. 1.

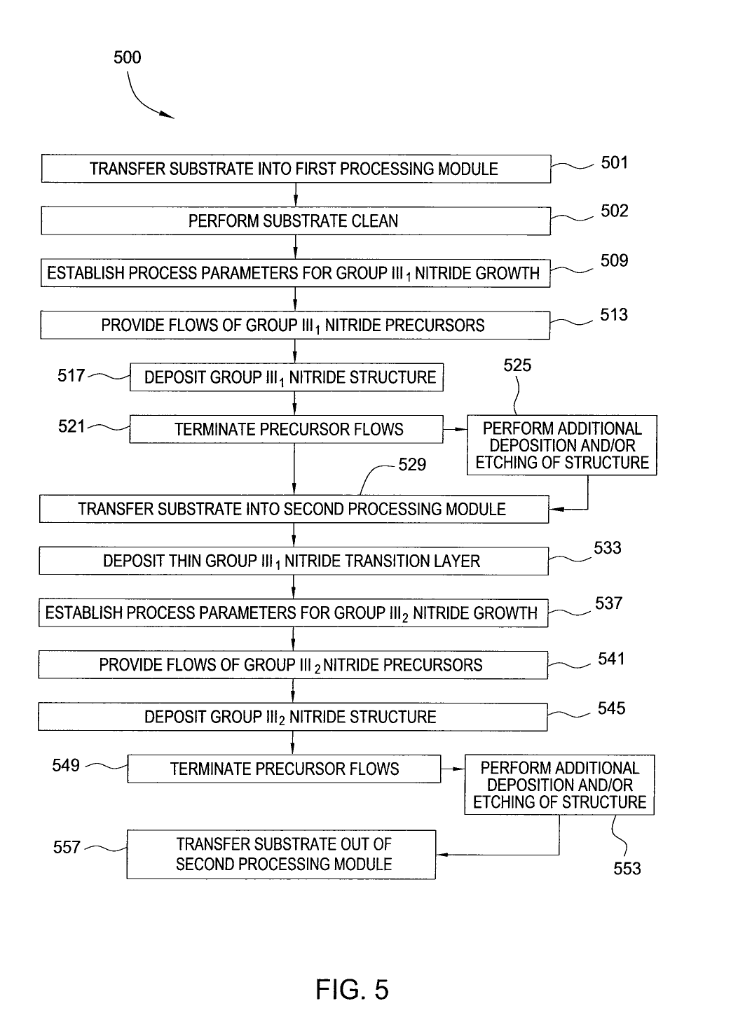

FIG. 5 illustrates a process sequence for fabricating a compound nitride semiconductor structure using the processing system shown in FIG. 4A according to one embodiment. The process sequence 500 starts at step 501 with one or more substrates “S” being transferred by robot 420 into a first substrate processing module 401. The substrates are then cleaned in the substrate processing chamber of substrate processing module 401 at step 502. Next, at step 509, desired film growth parameters, such as temperature, pressure, and the like, are established for the processing chamber for an initial epitaxial deposition layer. Precursor flows are provided at step 513 to deposit a Group 111₁ nitride structure. The precursors include a nitrogen source and a source for a first Group III (Group III₁) element such as gallium (Ga). For example, ammonia (NH₃) may be used for the nitrogen source and trimethyl gallium (“TMG”) may be used as a Ga source. The Group III₁ element may sometimes comprise a plurality of distinct Group III elements such as aluminum (Al) and Ga, and a suitable Al source may be trimethyl aluminum (“TMA”). In another example, the plurality of distinct Group III elements includes indium (In) and Ga, and a suitable In precursor may be trimethyl indium (“TMI”). A flow of carrier gas such as nitrogen and/or hydrogen may also be included.

After deposition of the Group III₁ nitride structure in step 517, the precursor flows are ended at step 521. Additional processing steps, such as further deposition and/or etching steps, may be performed on the compound nitride semiconductor structure at step 525, depending on the particular structure being formed.

The substrates are then transferred from the first substrate processing module 401 to a second substrate processing module 402 at step 529. In another embodiment, any substrate processing module sequence may be used so long as the first and second processing modules are different processing modules. The transfer may take place in a high purity gas environment at elevated temperature, and some gases which may be used for the high purity gas environment are nitrogen, hydrogen, or ammonia. In step 533, a thin Group III₁ nitride transition layer is deposited over the Group III₁ nitride structure. The same precursors used for the Group III₁ nitride structure in substrate processing module 401 may be used for the transition layer, but different precursors may also be used.

Next, at step 537, desired film growth parameters, such as temperature, pressure, and the like, are established for deposition of a Group III₂ nitride layer. Precursor gas flows are provided at step 541 for the Group III₂ nitride layer deposition, at step 545, and the Group III₂ element is different from the Group III₁ element, although the Group III₁ nitride and Group III₂ nitride layers may share a common Group III element. For example, if the Group III₁ nitride layer is GaN, the Group III₂ nitride layer may be an AlGaN layer or an InGaN layer. In another example, the Group III₂ nitride layer may have a quaternary rather than tertiary composition, such as AlInGaN. In the case where the Group III₁ nitride layer is AlGaN, the Group III₂ nitride layer may be an InGaN layer on an AlInGaN layer. Suitable precursors for the deposition of the Group III₂ nitride layer may be similar to the precursors used for the Group III₁ nitride layer and describe above. Likewise, similar carrier gases may also be used. After deposition of the Group III₂ nitride layer, the precursor flows are terminated at step 549.

As describe above for the Group III₁ nitride structure, additional processing at step 553, which may include further deposition and/or etching, may be performed on the deposited Group III₂ nitride structure. When processing in the substrate processing module 402 is completed, the substrates are transferred out of the substrate processing module 402 as indicated in step 557.

In another embodiment, the substrates may be transferred out of the second module at step 557 and then transferred into another module, such as the first module substrate processing module 401 or into a third and different module for further processing. The sequence of transfers among different processing modules may be performed as appropriate for the fabrication of a specific device, and the invention is not limited to any number of processing modules and associated processing chambers that may be used in a particular fabrication process, nor by any particular number of times processes are performed in any individual processing modules of the cluster tool 400.

One or more metrology tools 300 and/or metrology chambers 405 may be integrated with cluster tool 400 to help ensure the quality of substrate processing at various steps of a process sequence, such as the process sequence described in FIG. 5, although the present invention may be used for the fabrication of any Group III-V structures, and is not restricted to Group III nitride structure. The metrology tools 300, sensors 301, and metrology chambers 405 may be used to provide measurement data which can be monitored by the system controller 161 during various stages of substrate processing such as Group III nitride film growth, for example, or other types of deposition and/or etch processes which are performed on cluster tool 400.

The measurement data which is sent to the system controller 161 may then be viewed at an operator interface 167 so that processing parameters, such as film growth parameters, may be manually adjusted to optimize substrate processing or correct for any drift away from optimum processing parameters. In another embodiment, the system controller 161 may be adapted for closed-loop control so that the system controller 161 can automatically adjust the processing parameters as required based on metrology measurement data which is acquired during substrate processing or before or after substrate processing.

Closed-loop control of various stages of substrate processing offers several advantages. The system controller 161 may be able to detect and react to a drift away from predetermined processing parameter values more efficiently than a human operator since the rate of drift may be so rapid or gradual that it may go un-noticed by a human operator. Also, the system controller 161 and/or inter-system controller 470 can more easily monitor large amounts of metrology and processing data for one or more cluster tools 400 or multi-system processing system 475.

In one embodiment, the system controller 161 and/or inter-system controller 470, one or more cluster tools 400, metrology tools 300, sensors 301, 302, and metrology chambers 405 form a closed-loop control system. In one embodiment, the closed-loop control system is adapted to monitor various substrate processing operations using statistical process control (SPC) methodologies which are applied to process measurement data collected from one or more metrology tools 300, sensors 301, and metrology chambers 405 to detect process drift from pre-set or target process parameter values. Any detected process drift is then automatically corrected using a feedback control mechanism, such as a proportional-integral-derivative (PID) controller, which can control various process chamber operating parameters, such as temperature, pressure, gas flows, and the like, so that the processing parameters are automatically returned to the desired setpoints.

In one embodiment, the closed-loop control system may be used to monitor and automatically correct for any deviations from process parameter setpoints which occur within a processing run or from one processing run to another. Here, a processing run may refer to a complete processing sequence, such as a deposition, etch or other processing sequence, which is performed within a single processing chamber without transfer to another processing chamber. For example, the Group III₁ nitride deposition of step 533 may be defined as one processing run. The Group III₂ nitride deposition of step 545 may be defined as a second processing run, with both runs occurring within the same processing chamber of substrate processing module 402. The closed loop control system may be adapted to monitor and control substrate processing within a single processing run and from one processing run to another within the same processing chamber and/or from one processing chamber to another, and from one cluster tool 400 to another within a multi-system processing system 475.

For example, in-situ measurements using metrology tools 300 may be made to monitor film growth parameters, such as film growth rate, temperature, pressure, precursor flow rates, and the like, during the Group III₁ nitride deposition processing run of step 533 in the processing chamber of substrate processing module 402. This in-situ measurement data may then be used to detect any process drift and the closed loop control system can make real-time adjustments in the film growth parameters as required to correct for the drift. Also, the closed loop control system may also be adapted to store and utilize this measurement data to adjust the film growth parameters setpoints to optimize substrate processing for a subsequent Group III₁ nitride deposition processing run within the same processing chamber.

In another example, the closed loop control system may be adapted to monitor and control substrate processing from one processing chamber to another processing chamber, such as the Group III₁ nitride deposition of step 517 in the processing chamber of substrate processing module 401 and the Group III₁ nitride deposition of step 533 in the processing chamber of substrate processing module 402, and substrate processing module 401 and substrate processing module 402 may be on different cluster tools 400 of a multi-system processing system 475.

In one embodiment, the closed loop control system may be adapted to use in-situ measurement data to assign high-level film layer properties such as thickness, doping level, composition, and others as the processing parameters. In other words, the closed loop control system may be suitably adapted and configured with the appropriate software and metrology tools 300 so that the processing parameter setpoints are layer properties rather than processing parameters such as temperature, pressure, precursor flow rates, and the like.

In addition to the above examples of in-situ process monitoring and control, the closed loop control system may also be adapted to store and utilize measurement data which is obtained using one or more metrology chambers 405 after or before various substrate processing steps or runs, and use this data to detect and correct process drift in subsequent processing steps or runs within one or more processing chambers, and/or use the data to calibrate process parameter setpoints for process optimization. For example, GaN film growth parameters such temperature, pressure, precursor flow rates, and the like may be determined from the film growth rates of GaN which are calibrated from the film growth parameters used in previous processing runs. Information on the film growth rates of GaN from previous processing runs may be used to optimize the film growth parameters to be used on subsequent runs. The film growth rate may be determined by taking film thickness measurements over a period of growth time.

As described above, the integration of one or more metrology tools 300 into the cluster tool 400 provides substrate processing data which allows a closed loop control system or human operator to adjust the substrate processing parameters of a process recipe to correct for process drift and/or to optimize the processing recipe. Depending upon the location of the one or more metrology tools 300, the processing measurement may be taken in-situ during processing or before or after substrate processing. One advantage of in-situ measurements is that process drift may be caught sooner and corrected, either by a closed loop control system or human operator, before one or more substrates are processed. In one embodiment, the one or more metrology measurements are taken in-situ and the measurement data is used to control one or more process recipes as the recipes are running.

While the foregoing is directed to embodiments of the present invention, other and further embodiments of the invention may be devised without departing from the basic scope thereof, and the scope thereof is determined by the claims that follow.

1. A substrate processing system comprising:
a chamber in which Group III-V films are deposited on a substrate, comprising:
one or more walls forming a processing volume;
a showerhead assembly defining a top portion of the processing volume;
a rotatable substrate carrier positioned below the showerhead assembly and defining a bottom portion of the processing volume, wherein the substrate carrier has multiple recesses for holding substrates;
one or more metrology tools adapted to measure a surface property of a substrate disposed on the substrate carrier; and
a system controller for controlling process parameters of said chamber in accordance with measurements taken by the metrology tools.

2. The system of claim 1, wherein at least one of the one or more metrology tools are disposed in the showerhead assembly.

3. The system of claim 1, wherein at least one of the one or more metrology tools is disposed in the one or more walls of the chamber.

4. The system of claim 1, wherein the Group III-V film is gallium nitride.

5. The system of claim 1, wherein the chamber is a metalorganic chemical vapor deposition (MOCVD) chamber or a hydride vapor phase epitaxy (HVPE) chamber.

6. The system of claim 1, wherein the one or more metrology tools are adapted to measure a property of a surface of the substrate using pyrometry, reflectometry, ellipsometry, photoluminescence spectroscopy, electroluminescence spectroscopy, X-Ray diffraction (XRD), or band edge thermometry techniques.

7. The system of claim 1, wherein the property of the surface of the substrate measured by the one or more metrology tools is a property selected from a group consisting of thickness, reflectance, material composition, stress, strain, photoluminescence, electroluminescence, or temperature.

8. A cluster tool comprising:
a transfer chamber;
a robot disposed in the transfer chamber;
one or more processing chambers in communication with the transfer chamber, wherein at least one of the processing chambers is adapted to deposit Group III-V films on a substrate;
a service chamber in communication with the transfer chamber;
one or more metrology tools adapted to measure a surface property of a substrate; and
a system controller for controlling process parameters of said one or more processing chambers in accordance with measurements taken by the metrology tools.

9. The cluster tool of claim 8, wherein at least one of the one or more metrology tools is disposed within the service chamber.

10. The cluster tool of claim 8, wherein at least one of the one or more metrology tools is coupled to and in fluid communication with the transfer chamber.

11. The cluster tool of claim 8, wherein at lease one of the one or more metrology tools is disposed within the transfer chamber.

12. The cluster tool of claim 8, wherein at least one of the one or more metrology tools is disposed within at least one processing chamber.

13. The cluster tool of claim 8, wherein at least one processing chamber is adapted for MOCVD or HVPE deposition.

14. The cluster tool of claim 8, wherein the one or more metrology tools are adapted to measure a property of a surface of the substrate using pyrometry, reflectometry, ellipsometry, photoluminescence spectroscopy, electroluminescence spectroscopy, XRD, or band edge thermometry techniques.

15. The cluster tool of claim 8, wherein the Group III-V film is gallium nitride.
